(19) United States
(12) Patent Application Publication
(10) Pub. No.: US 2022/0077616 A1
(43) Pub. Date: Mar. 10, 2022

(54) METAL MATERIAL AND CONNECTION TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Mikio SATO, Mie (JP); Yoshifumi SAKA, Mie (JP); Ryota MIZUTANI, Mie (JP); Akihiro KATO, Mie (JP)

(21) Appl. No.: 17/422,364

(22) PCT Filed: Jan. 17, 2020
(86) PCT No.: PCT/JP2020/001479

§ 371 Date: Jul. 12, 2021

(30) Foreign Application Priority Data
Jan. 18, 2019 (JP) 2019-007135

(51) Int. Cl. H01R 13/03; B32B 15/01; C23C 30/00

(52) U.S. Cl. CPC H01R 13/03; C23C 30/00; B32B 15/018

(57) ABSTRACT

Provided is a metal material and a connection terminal that have a surface layer including Au, and that can maintain a state of low contact resistance even when heated. A metal material 1 includes a base material 10 and a surface layer 11 formed on the base material 10. The surface layer 11 contains Au and In, and at least In is present at an outermost surface. Also, a connection terminal is constituted by the metal material 1, and the surface layer 11 is formed on a surface of the base material 10 at least at a contact portion that comes into electrical contact with a partner conductive member.

### TECHNICAL FIELD

The present disclosure relates to a metal material and a connection terminal.

### BACKGROUND

There are cases where a metal layer (Au layer) is provided on electrical connection members such as connection terminals. Gold (Au) has high electrical conductivity and a high melting point as well as being resistant to oxidization. Accordingly, electrical connection members provided with an Au layer on the surface thereof can be favorably used in cases where high-temperature environments are envisioned. For example, if a connection terminal provided with an Au layer on the surface thereof is used as a connection terminal in an environment in a vehicle that reaches high temperatures such as in the surrounding region of the engine, the Au layer surface maintains a state of low resistance and stable electrical conductivity can be obtained even if high temperatures are reached.

Au is a relatively soft metal, and when Au is provided on the surface of an electrical connection member such as a connection terminal, an increase in a friction coefficient during sliding or the like and insufficient hardness are likely to prove problematic. Thus, there are cases where a hard gold that is harder than pure Au is used. In order to form a hard gold layer, a plating liquid including an additional element such as Co is used as disclosed in Patent Document 1 and the like. By adding a small amount of Co to the Au layer formed through plating, the hardness of the Au layer can be increased.

### PRIOR ART DOCUMENT

### Patent Document

Patent Document 1: JP 2011-021217 A

### SUMMARY OF THE INVENTION

### Problems to be Solved

As described above, Au is a metal that is resistant to oxidization and thus, by providing an Au layer on the surface of an electrical connection member such as a connection terminal, the surface can be easily kept in a state of low contact resistance. However, when an Au layer is formed using hard gold, there are cases where, when the material thereof is heated due to a current passing therethrough or use in a high-temperature environment, additional elements such as Co added to the hard gold diffuses to the surface and oxidizes. Thus, there is a possibility that oxides of the additional elements will contribute to an increase in the contact resistance of the surface.

It is often the case that metals such as Ni which are more likely to oxidize than Au are used, in addition to the additional element in the hard gold, as a substrate or an intermediate layer located below the Au layer. Thus, even in case where these metals diffuse to the surface of the Au layer and oxidize when heated, there is a possibility that oxides of these metals will contribute to an increase in the contact resistance of the surface.

In view of the above-described circumstances, and an object of the present invention is to provide a metal material and a connection terminal that include a surface layer including Au and can maintain a state of low contact resistance.

### Means to Solve the Problem

A metal material of the present disclosure includes a base material and a surface layer formed on the base material, wherein the surface layer contains Au and In, and at least In is present at an outermost surface.

A connection terminal disclosed in the present disclosure is constituted by a metal material such as that described above, wherein the surface layer is formed on a surface of the base material at least at a contact portion thereof that comes into electrical contact with a partner conductive member.

### Effect of the Invention

The metal material and the connection terminal according to the present disclosure include a surface layer including Au and can maintain a state of low contact resistance even when heated.

### BRIEF DESCRIPTION OF THE DRAWINGS

FIGS. 1A to 1C are cross-sectional diagrams schematically showing a layered structure of a metal material according to an embodiment of the present disclosure. FIG. 1A is a cross-sectional view of the overall configuration of an example in which a surface layer has a multi-layer structure, and FIG. 1B is a cross-sectional view of the overall configuration of an example in which the surface layer has a single-layer structure. FIG. 1C is an enlargement of the example of a state in which the surface layer has a single-layer structure.

FIG. 2 is a cross-sectional view schematically showing a connection terminal according to an embodiment of the present disclosure.

FIGS. 3A to 3C are diagrams respectively showing element concentration distributions of heated samples, the distributions being obtained using depth-analysis Auger electron spectroscopy. FIG. 3A is a diagram illustrating sample A1, FIG. 3B is a diagram illustrating sample A2, and FIG. 3C is a diagram illustrating sample B1.

FIG. 4 is a diagram illustrating the X-ray diffraction results of sample A1.

FIGS. 5A to 5C are diagrams illustrating the initial state and post-heating state of the contact resistance of each sample. FIG. 5A is a diagram illustrating sample A1, FIG. 5B is a diagram illustrating sample A2, and FIG. 5C is a diagram illustrating sample B1.

### DETAILED DESCRIPTION TO EXECUTE THE INVENTION

### Description of Embodiments of Disclosure

First, embodiments of the present disclosure will be listed and described.

A metal material disclosed in the present disclosure includes a base material and a surface layer formed on the base material, wherein the surface layer contains Au and In, and at least In is present at an outermost surface.

The metal material according to the present disclosure contains In in addition to Au in the surface layer. As a result of the surface layer containing In, when the metal material reaches a high temperature, metals other than Au and In present in or below the surface layer (other metals) are kept from diffusing to the outermost surface. As a result, an increase in contact resistance due to oxidization of the other metals in the outermost surface is less likely to occur, and low contact resistance obtained due to Au having high electrical conductivity and oxidization resistance can be maintained before and after heating. Even if In oxidizes in the outermost surface, an oxide film can be easily broken by applying a load thereto, and thus is unlikely to contribute to an increase in contact resistance.

Here, it is preferable that at least one of the surface layer and the base material contains an easily oxidizable metal, other than In, that is more susceptible to oxidization than Au, and when the metal material is heated to 170° C., an increase in the concentration of the easily oxidizable metal in the outermost surface is below a detection limit in Auger electron spectroscopy. This means that, in this case, due to the effect of In being contained in the surface layer, the easily oxidizable metals are sufficiently kept from diffusing to the outermost surface when the metal material is heated. Accordingly, an increase in the contact resistance due to oxidization of easily oxidizable metals in the outermost surface can be effectively suppressed.

It is preferable that at least a portion of In in the surface layer forms an Au—In alloy. In doing so, the surface layer that includes In in addition to Au can be easily formed and maintained. The Au—In alloy has the effect of keeping other metals present in and below the surface layer from diffusing to the outermost surface, due to the contribution of In. The oxide film formed on the surface has the property of being easily broken. Accordingly, the Au—In alloy exhibits an excellent effect of suppressing an increase in the contact resistance of the surface layer during heating.

In this case, it is preferable that at least a portion of the Au—In alloy is a solid solution in which In is solidified in Au. Thus, In has the property of easily solidifying in Au, and thus the surface layer including In in addition to Au can be stably formed and have increased environmental stability.

It is preferable that both Au and In are present in the outermost surface of the surface layer. In doing so, both the high electrical conductivity and oxidization resistance of Au and the effect of suppressing the diffusion of other metals realized by In can be effectively used in the outermost surface, and a surface layer with low contact resistance before and after heating can be formed.

It is preferable that the surface layer includes an Au portion of which the main component is Au, and a high-concentration In portion containing a higher concentration of In than the Au portion. In doing so, as a result of the high-concentration In portion with a high concentration of In being formed, the diffusion of other metals can be effectively suppressed by the high-concentration In portion.

In this case, it is preferable that the high-concentration In is formed on a surface of the Au portion and is exposed at the outermost surface. In doing so, as a result of the high-concentration In portion forming the outermost surface of the surface layer, an increase in contact resistance caused by other metals diffusing to the outermost surface during heating and oxidizing can be effectively suppressed.

Alternatively, it is preferable that an entirety of the surface layer has a single-layer structure constituted by a single layer including an Au—In alloy. Even when the surface layer has a single-layer structure, diffusion and oxidization of other metals to the outermost surface due to heating can be suppressed as a result of the surface layer containing In. Even if a surface layer with a single-layer structure is entirely formed of a homogeneous Au—In alloy, the surface layer may have two phases, namely an Au portion with a comparatively high Au concentration and a high-concentration In portion with a comparatively high In concentration. When the surface layer is formed by layering an Au layer and an In layer in this order, if the content of In is set higher than Au, a single-layer structure is likely to be formed.

It is preferable that In is distributed in a region spanning from the outermost surface to at least a depth of 0.01 μm. Furthermore, it is preferable that In is distributed in a region spanning from the outermost surface to at least a depth of 0.05 μm. In doing so, the diffusion of other metals during heating and an increase in contact resistance can be sufficiently suppressed with ease by In.

It is preferable that the base material has an intermediate layer formed on a substrate, and the intermediate layer includes at least one of Ni, Cr, Mn, Fe, Co, and Cu. In doing so, while these metals are susceptible to oxidization, adding In to the surface layer makes it less likely that they diffuse to the surface layer during heating and become oxidized and cause an increase in contact resistance.

It is preferable that the surface layer contains Co. In doing so, the hardness of the surface layer can be increased due to the effect of containing Co. Co is a metal that is likely to diffuse to the surface of the layer including Au and oxidize when heated and cause an increase in contact resistance, but because In is contained in the surface layer, the diffusion of Co is suppressed and a state of low contact resistance can be easily maintained.

It is preferable that the content of an additional element other than Au and In in the surface layer is 5% or less. In doing so, properties imparted to the surface layer by Au and In are unlikely to be impaired by adding additional elements.

It is preferable that the In content of the surface layer overall is 10% or more in terms of atomic ratio relative to Au. In doing so, properties imparted to the surface layer by In such as suppressing the diffusion of other metals can be effectively exhibited.

It is preferable that the content of In, in terms of the number of atoms, in the surface layer overall is smaller than that of Au. In doing so, properties imparted to the surface layer by Au such as reducing contact resistance of a surface can be effectively exhibited.

It is preferable that the thickness of the surface layer is 0.1 μm or more. In doing so, the properties imparted to the surface layer by Au and In can be sufficiently exhibited.

A connection terminal according to the present disclosure is constituted by the metal material, and the surface layer is formed at least on a surface of the base material at a contact portion that comes into electrical contact with a partner conductive member. The connection terminal according to the present disclosure is provided with a surface layer such as that described above at least on the contact portion, and thus low contact resistance can be maintained on the contact portion even after being heated.

### Detailed Embodiments of Disclosure

Embodiments of the present disclosure will be described below with reference to the drawings. In the present specification, unless specified otherwise, the content (concentration) of each element is represented in a unit of atomic ratio such as at %. Also, it is to be appreciated that cases in which individual metals contain unavoidable impurities are also included. It is to be appreciated that, unless specified otherwise, cases in which an alloy is a solid solution and cases in which an alloy forms an intermetallic compound are also included. In regards to alloy compositions, it is to be appreciated that the phrase “a metal element is the main component” refers to a state where that element makes up 50 at % or more of all metal types of the composition.

[1] Metal Material

The metal material according to an embodiment of the present disclosure is formed by layering metal materials. The metal material according to an embodiment of the present disclosure may form any metal member, and can be favorably used as a material for forming an electrical connection member such as a connection terminal.

(Configuration of Metal Material)

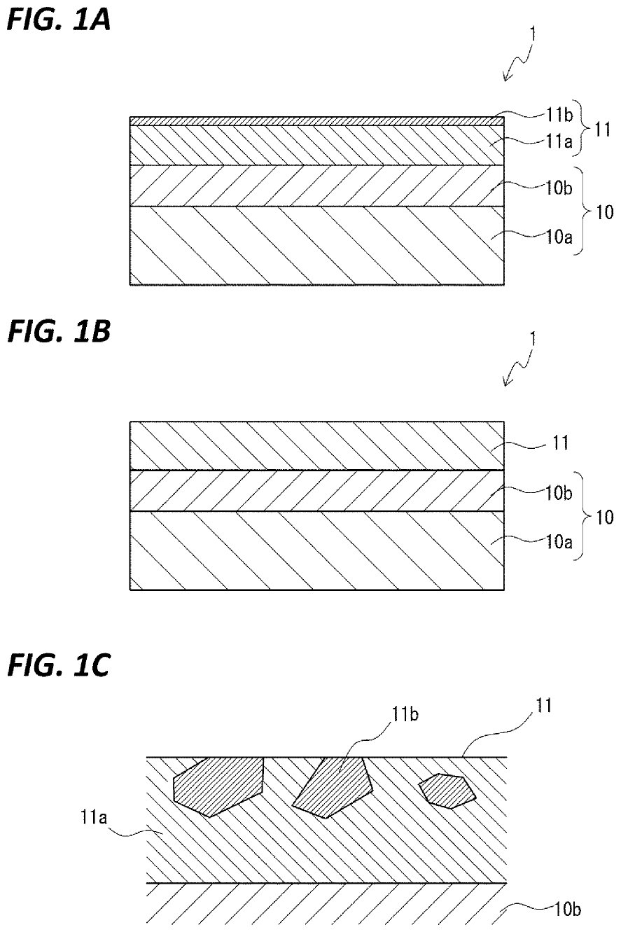

FIGS. 1A and 1B show an example of a layered structure of a metal material 1 according to an embodiment of the present disclosure. The metal material 1 includes a base material 10 and a surface layer 11 that is formed on the surface of the base material 10 and is exposed as the outermost surface. As described below, the surface layer 11 includes gold (Au) and indium (In) and may have a multi-layer structure as shown in FIG. 1A or a single-layer structure as shown in FIG. 1B. Provided that the properties of the surface layer 11 are not degraded, a thin film (not shown) such as an organic layer may be provided on the surface layer 11 exposed at the outermost surface of the metal material 1.

The base material 10 may be formed of one single metal material but it is preferable that it includes a substrate 10a and an intermediate layer 10b. The intermediate layer 10b is formed as a metal layer that is thinner than the substrate 10a, on the surface of the substrate 10a.

The substrate 10a can be constituted by a metal material in any shape such as a plate shape. There is no particular limitation on the material that constitutes the substrate 10a, but if the metal material 1 is configured as an electrical connection member such as a connection terminal, Cu, a Cu alloy, Al, an Al alloy, Fe, an Fe alloy, or the like can be preferably used as the material that constitutes the substrate 10a. Of these materials, Cu or a Cu alloy that are highly electrically conductive can be favorably used.

As a result of providing the intermediate layer 10b in contact with the surface of the substrate 10a, effects such as increasing close contact between the substrate 10a and the surface layer 11 and the effect of suppressing mutual diffusion of constituent elements between the substrate 10a and the surface layer 11 can be obtained. As a material with which the intermediate layer 10b can be formed, a metal material containing at least one selected from a group of Ni, Cr, Mn, Fe, Co, Cu (group A) can be given as an example. The material constituting the intermediate layer 10b may be a single type of metal selected from group A or may be an alloy containing one or two or more types of metal elements selected from group A. If an alloy is employed, an alloy including a metal element in addition to a metal element selected from group A may be used, but it is preferable that a metal element selected from group A forms the main component. Also, the intermediate layer 10b may be a single layer or a laminate including two or more types of layers. Even if the base material 10 does not include the intermediate layer 10b and is made of a single metal material, it is preferable that at least the surface of the single metal material is formed of a metal containing at least one material selected from group A.

If the substrate 10a is formed of Cu or a Cu alloy, by forming the intermediate layer 10b using a metal containing at least one material selected from the above group A, specifically a metal in which the main component thereof is a metal element selected from group A, diffusion of Cu from the substrate 10a to the surface layer 11 as well as consumption and the like of In caused by alloying with the diffused Cu and the component composition or the properties of the surface layer 11 being affected can be effectively suppressed even under high-temperature conditions. In particular, if the intermediate layer 10b is made of Ni or an alloy with Ni as the main component, the suppression of diffusion of Cu to the surface layer 11 can be effectively achieved.

There is no particular limitation on the thickness of the intermediate layer 10b, but in view of effectively achieving suppression of diffusion between the substrate 10a and the surface layer 11 and the like, the thickness is preferably 0.1 μm or more. On the other hand, in view of preventing an excessively thick intermediate layer 10b, the thickness is preferably 3 μm or less. A portion of the intermediate layer 10b on the substrate 10a side may form an alloy with the constituent element of the substrate 10a, and a portion on the surface layer 11 side may form an alloy with the constituent element of the surface layer 11.

The surface layer 11 is configured as a metal layer containing Au and In. The surface layer 11 may contain an element other than Au and In. For example, a form containing an element that is effective at hardening Au such as Co can be given as an example. Note that, as described below, the content of an additional element such as Co in the surface layer 11 is preferably kept to 5% or less such that the properties imparted by Au and In are not impaired.

As long as the surface layer 11 contains Au and In and the outermost surface has at least In atoms, there is no particular limitation on the distribution of Au and In in the surface layer 11. Au and In may be present as individual metals or form an alloy. A portion formed by a single metal and a portion forming an alloy may be present together. In view of stably maintaining the state of the surface layer 11 and increasing environmental stability, it is preferable that at least a portion of In contained in the surface layer 11 or desirably most of the In contained in the surface layer 11 forms an Au—In alloy. The Au—In alloy may be a solid solution or an intermetallic compound, but the In is likely to be in the state of a solid solution solidified in the lattice of Au.

Also, the surface layer 11 may have a multi-layer structure, as shown in FIG. 1A, in which a plurality of layers (11a and 11b) of different component compositions are layered or a single-layer structure, as shown in FIG. 1B, configured as an overall single layer without a clear layered structure. Furthermore, if a single-layer structure is employed, only one alloy phase may be formed in the layer of the surface layer 11 or a plurality of alloy phases (11a and 11b) may be intermixed in the layer, as shown in FIG. 1C. As described later, if the surface layer 11 is formed by layering an Au layer and an In layer, which are raw material layers, in this order, the surface layer 11 is likely to have a multi-layer structure if the In layer is made thin, but if the In layer is comparatively thick and the content of In relative to Au is set high, the surface layer 11 is likely to have a single-layer structure.

Particularly when the surface layer 11 has a single-layer structure, the surface layer 11 may be formed by an overall homogeneous Au—In alloy. However, if either the single-layer structure or the multi-layer structure is to be employed, it is preferable that two types of phases, namely an Au portion 11a in which the concentration of Au is comparatively high and an In portion 11b in which the concentration of In is comparatively high, are included.

For example, in the multi-layer structured surface layer 11 shown in FIG. 1A, the layer on the base material 10 side (lower layer) can be constituted by the Au portion 11a, and the layer formed on the surface of the Au portion 11a and exposed as the outermost surface (upper layer) can be constituted by the high-density In portion 11b. Also, in the single-layer structured surface layer 11 shown in FIG. 1B, a structure can be employed in which the Au portion 11a and the high-concentration In portion 11b are both present in the layer, as shown in FIG. 1C. At this time, as shown in FIG. 1C, a form in which the high-concentration In portion 11b is present so as to be dispersed in the Au 11a portion is likely to occur. In the single-layer structure, the Au portion 11a and the high-concentration In portions 11b preferably are exposed together in the outermost surface of the surface layer 11.

The Au portion 11a has Au as the main component, and examples of forms include being formed by Au alone (also includes cases where additional elements such as Co are included; the same applies below) and being formed of an Au—In alloy including less In than Au. In view of sufficiently exhibiting the properties of Au, it is preferable that the Au portion 11a is made of Au alone.

The high-concentration In portions 11b contain a higher concentration of In than the Au portion 11a. Specifically, an example of a form of the high-concentration In portions 11b can be given in which they are formed of In alone, or are formed as an Au—In alloy with a higher concentration (atomic ratio of In to Au) of In than that of the Au portion 11a.

The Au portion 11a and the high-concentration In portions 11b may both be formed of an Au—In alloy, but in that case, the high-concentration In portions 11b have an alloy composition in which the atomic ratio of In to Au is higher than that of the Au portion 11a. Also, the Au portion 11a and the high-concentration In portions 11b may each contain two or more types of portions with different compositions, examples of which include a form containing both a single metal and an alloy and a form containing two or more alloys with different component compositions.

In the case where the surface layer 11 has a multi-layer structure as shown in FIG. 1A, if the high-concentration In portion 11b, which is the upper layer, is made of In alone, only In and not Au will be present in the outermost surface. On the other hand, in the case where the high-concentration In portion 11b that is the upper layer in the multi-layer structure is formed of an Au—In alloy, or in the case where the surface layer 11 has a multi-layer structure as shown in FIG. 1B, both Au and In will be present in the outermost surface.

The content ratio of In and Au in the surface layer 11 may be suitably set according to the desired properties of the surface layer 11, but as described below, in view of effectively exhibiting properties imparted by In such as suppressing the diffusion of other types of metal, the content of In is preferably 10% or more in an atomic ratio relative to Au (I [at %]/Au [at %]), in the overall surface layer 11 (the sum of the Au portion 11a and the high-concentration In portion 11b). On the other hand, in view of effectively exhibiting properties imparted by Au, such as reducing surface contact resistance, the In content of the overall surface layer 11 is preferably smaller than that of Au. Furthermore, the atomic ratio of In to Au is preferably 70% or less.

In is distributed in at least the outermost surface of the surface layer 11, but it is preferable that In is distributed throughout a region spanning from the outermost surface to a certain depth therefrom. Specifically, it is preferable that In is distributed in a region spanning from the outermost surface to a depth of 0.01 μm, and more preferably to a depth of 0.05 μm. In this case, even if In is present as a single metal, the In may be in the state of an Au—In alloy such as a solid solution. Here, the distribution of In over a region to a predetermined depth can be provided, as described in a following working example, by detecting the presence of In exceeding a detection limit in a region spanning from the outermost surface to the predetermined depth by using a depth-analysis Auger electron spectroscope (AES) that employs sputtering or depth-analysis x-ray photoelectron spectroscopy (XPS). The detection limit of AES or XPS is approximately 0.1-1.0 at %.

There is no particular limit on the overall thickness of the surface layer 11 and it is sufficient that properties imparted by Au and In are sufficiently exhibited. For example, it is preferable to set the thickness to 0.1 μm or more. On the other hand, in view of avoiding forming an excessively thick surface layer 11, the thickness is preferably 1 μm or less. In the case where the surface layer 11 has a multi-layer structure as shown in FIG. 1A, the thickness of the upper layer formed by the high-concentration In portion 11b is preferably 0.01 μm or more. On the other hand, the thickness thereof is preferably 0.5 μm or less.

(Surface Properties of Metal Material)

As described above, the surface layer 11 of the metal material 1 includes both Au and In. Thus, the surface layer 11 exhibits low contact resistance and also can maintain a state of low contact resistance even after being heated.

Specifically, as a result of the surface layer 11 containing Au, high heat resistance and electrical conductivity of Au can be utilized. Also, Au is a metal that is highly resistant to oxidization, and thus even if the surface layer 11 is heated, the surface is likely to maintain a state of high electrical conductivity, and maintain a state of low contact resistance prior to and after heating.

As a result of the surface layer 11 containing In, metal elements (other metals) other than In and Au can be kept from diffusing to the outermost surface. Here, a metal forming the base material 10 can be given as an example of another type of metal. Specifically, elements such as Ni forming the intermediate layer 10b can be given as an example. Additionally, in a case where additional elements such as Co are added to the surface layer 11 with the aim of hardening Au, these additional elements are also considered as other metals.

Assuming that the surface layer 11 does not contain In, when the metal material 1 is heated due to a current passing through the metal material 1 or use in a high-temperature environment, there will be cases where other metals diffuse in the surface layer 11 and reach the outermost surface. In particular, if the other metals are easily oxidizable metals more prone to oxidization than Au, such as Ni or Co, when the easily oxidizable metals present below the surface layer 11 (that is, the base material 10) or in the surface layer 11 are heated, these other metals diffuse to the surface layer 11 and concentrate in the outermost surface where they oxidize. Oxides formed in the outermost surface contribute to an increase in the contact resistance of the surface layer 11.

However, due to In being contained in the surface layer 11, when the metal material 1 is heated, In acts to suppress the diffusion of other metals to the outermost surface. By keeping other metals from diffusing to the outermost surface, an increase in contact resistance of the surface layer 11 due to oxidization of other metals that have diffused to the outermost surface can be suppressed. That is, the surface layer 11 can maintain low contact resistance imparted by Au even after being heated, as a result of containing In. The effect of suppressing the diffusion of other metals can be exhibited with In alone and also with an Au—In alloy including a solid solution.

In itself is more susceptible to oxidization than Au, and In contained in the surface layer 11 also oxidizes when heated or the like. However, an oxide layer formed on the surface of In alone or an Au—In alloy is comparatively soft and can be easily broken by applying a load or the like. Accordingly, even if In contained in the surface layer 11 undergoes oxidization in the outermost surface, the contact resistance of the surface layer 11 is not largely increased. In this way, due to In suppressing the diffusion of other metals and having an easily breakable oxide film, a low contact resistance state of the surface layer 11 imparted by Au can be maintained prior to and after heating.

In the case where other metals that are easily oxidizable such as Ni or the like contained in the base material 10 or Co or the like contained in the surface layer 11, and in particular in the Au portion 11a, are present on the lower side of or in the surface layer 11, by adding In to the surface layer 11 in addition to Au, an increase in the concentration of the easily oxidizable metals in the outermost surface of the surface layer 11 when, for example, the surface layer 11 is heated to 170° C. as also described in a later embodiment, can be suppressed to below the detection limit. That is, the concentration distribution, in the outermost surface of the surface layer 11, of easily oxidizable metals such as Ni contained in the base material 10 and not contained in the original surface layer 11 can be kept below a detection limit before and after heating at 170° C., and after being heated at 170° C., the amount of the increase in the concentration of easily oxidizable metals, such as Co added to the original surface layer 11, from that of the concentration in the outermost surface prior to heating can be kept below the detection limit. Here, as a measuring means for defining the detection limit, AES can be used for example. As described above, the detection limit of AES is approximately 0.1-1.0 at %.

In this way, by adding In to the surface layer 11, an increase in the concentration of easily oxidizable metals in the outermost surface due to the application of heat can be limited, and thus an increase in the contact resistance at the time of heating can be effectively suppressed. The heating time for determining the presence or absence of an increase in the concentration of easily oxidizable metals can be 120 hours or more, for example. In particular, if In is distributed in the surface layer 11 throughout a region spanning at least from the outermost surface to a depth of 0.01 μm, and further to a depth of 0.05 μm, the effect of suppressing an increase in contact resistance due to diffusion of easily oxidizable metals can be obtained with sufficient ease.

If the surface layer 11 has a multi-layer structure as shown in FIG. 1A, the surface of the Au portion 11a, the main component thereof being Au, is covered by the high-concentration In portion 11b formed of In alone or an Au—In alloy with a high In content. The overall outermost surface of the metal material 1 is formed of the high-concentration In portion 11b, and thus other easily oxidizable metals such as Ni or Co contained in the base material 10 or the surface layer 11 (in particular, the Au portion 11a) can be effectively kept from diffusing due to being heated, reaching the outermost surface of the surface layer 11, and oxidizing.

On the other hand, in the case where the surface layer 11 has a single-layer structure as shown in FIG. 1B, if the overall surface layer 11 of the single-layer structure is formed of an Au—In phase, the Au—In alloy suppresses the diffusion of other metals to the outermost surface and oxidization thereof due to the effect of containing In, and thus plays a role in suppressing an increase in contact resistance during heating. If the surface layer 11 with a single-layer structure is formed of the Au portion 11a and the high-concentration In portion 11b, as shown in FIG. 1C, the diffusion of other metals to the outermost surface and oxidization thereof can be suppressed in at least the portion where the high-concentration In portion 11b is formed. As a result, an increase in the contact resistance of the overall surface layer 11 in which the Au portion 11a and the high-concentration In portion 11b are intermixed can be suppressed during heating. In the case where the Au portion 11a is formed of an Au—In alloy with a lower concentration of In that the high-concentration In portion 11b, instead of Au alone, In in the Au portion 11a as well plays a role in suppressing diffusion of other metals to the outermost surface and the oxidization thereof, and thus the effect of suppressing an increase in contact resistance during heating can be particularly improved. In the case where the surface layer 11 has a single-layer structure in which the high-concentration In portions 11b and the Au portion 11a are both present, unlike the case where the surface layer 11 has a multi-layer structure in which the overall outermost surface is formed of the high-concentration In portion 11b, the Au portion 11a, which is less effective at suppressing the diffusion of other metals than the high-concentration In portions 11b, is also exposed at the outermost surface of the surface layer 11, but as described above, a single-layer structure is easier to form when the content ratio of In relative to Au in the overall surface layer 11 is high, and as a result of the In concentration being high, the same effect of suppressing an increase in contact resistance during heating as when a multi-layer structure is employed and an effect of the same greater than that when a multi-layer structure is employed can be exhibited.

As described above, alloying of In and Au can easily proceed at room temperature as well, and thus it is preferable that at least a portion of In contained in the surface layer 11 forms an Au—In alloy, such as In being a solid solution solidified in Au. In particular, if the surface layer 11 has a single-layer structure as shown in FIG. 1B, it is preferable that, for example, the high-concentration In portion 11b (and the Au portion 11a) contained as In is in the state of a solid solution solidified in Au. As a result of Au and In forming an alloy, the state of the surface layer 11 such as the state in which the Au portion 11a and the high-concentration In portions 11b are present together is easy to stably maintain. The Au—In alloy is likely to be formed in a state where In is a solid solution solidified in Au in at least a region with low In content, but by increasing the content of In or the like, an Au—In intermetallic compound can also be formed. In the case where an Au—In alloy is to be formed as a solid solution or as an intermetallic compound, or if an intermetallic compound is to be formed, the composition thereof can be controlled according to the ratio of the amount of Au and In used as the raw material for forming the surface layer 11 or forming conditions and the like of the surface layer 11.

As a result of the metal material 1 according to the present embodiment having the surface layer 11 as described above, low contact resistance can be expressed as well as being able to maintain the state of low contact resistance even after being heated. Accordingly, the metal member 1 can favorably be used in applications as an electrical connection member in which the surface of the surface layer 11 of an electrical component, in particular, a connection terminal or the like comes in contact with a partner conductive member.

(Method for Manufacturing Metal Material)

The metal material 1 according to the present embodiment can be manufactured by forming the intermediate layer 10b using a plating method or the like as necessary on the surface of the substrate 10a, and then forming the surface layer 11.

The surface layer 11 may be formed using any method such as a vapor deposition method, an immersion method, and a plating method, but the immersion method and the plating method can be favorably used. At this time, the surface layer 11 including both Au and In may be formed in a single operation using an immersion liquid or a plating liquid, but in view of convenience, the surface layer 11 can be formed by layering an Au layer and an In layer in this order, and then allowing an alloy to form as necessary.

One example is a form in which an Au layer is formed using a plating method and then an In layer is formed on the surface thereof using an immersion method or a plating method. In the case where the In layer is formed using an immersion method, a thin In layer is formed, and the surface layer 11 such as that shown in FIG. 1A, which has a multi-layer structure, with the Au portion 11a as the lower layer thereof and the high-concentration In portion 11b as the upper layer thereof can be easily formed. On the other hand, in the case where the In layer is formed using the plating method, a comparatively thick In layer can be formed, and the surface layer 11 as shown in FIG. 1B, which has a single-layer structure, including an Au—In alloy obtained through alloying can be easily formed. Alloying of Au and In also progresses at room temperature, and thus at least a portion of In can form an alloy with Au without particularly heating a laminate of an Au layer and an In layer, but alloying may be promoted through heating.

The ratio of the thicknesses of the Au layer and the In layer, which are raw material layers, and the thickness therebetween can be selected as appropriate according to the desired thickness of the surface layer 11, component compositions, or the like, but a form in which the Au layer has a thickness of 0.1 to 1 μm and the In layer has a thickness of 0.01 to 0.5 μm can be given as an example of a preferred form. It is preferable that the Au layer is formed in advance as a hard gold layer containing additional elements such as Co. By using a hard gold layer as a raw material layer, the hardness of the formed surface layer 11 can be increased. By using a hard gold layer, even if additional elements such as Co are contained in the formed surface layer 11, as described above, due to the presence of In as well, an increase in content during heating caused by diffusion of additional elements to the outermost surface and oxidization thereof can be sufficiently suppressed.

[2] Connection Terminal

The connection terminal according to an embodiment of the present disclosure is configured by the metal material 1 according to the above-described embodiment in which the surface layer 11 including Au and In is formed on the surface of the base material 10 at least at a contact portion thereof that comes into electrical contact with a partner conductive member. The shape and type of the connection terminal are not particularly limited.

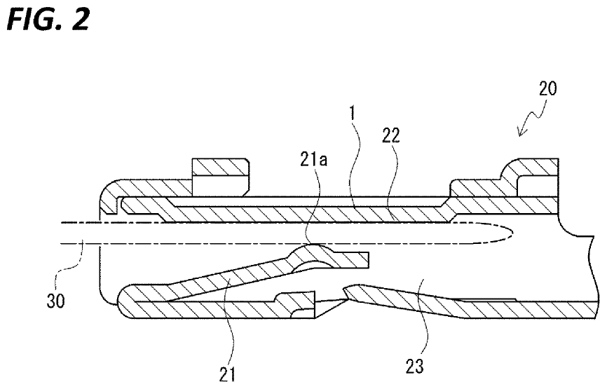

FIG. 2 shows a female connector terminal 20 as an example of the connection terminal according to the embodiment of the present disclosure. The female connection terminal 20 has a similar shape to that of a known fitting female connector terminal. That is, a rectangular tubular pinching portion 23 that is open forward is provided, and an elastic contact piece 21 is provided on the inner side of the bottom surface of the pinching portion 23, the elastic contact piece 23 being folded back rearward on the inner side. When a planar-type tab-shaped male connector terminal 30, which is the partner conductive member, is inserted into the pinching portion 23 of the female connector terminal 20, the elastic contact piece 21 of the female connector terminal 20 comes into contact with the male connector terminal 30 at an embossed portion 21a that bulges to the inner side of the pinching portion 23, and an upward force is applied to the male connector terminal 30. The surface of the ceiling portion of the pinching portion 23 that opposes the elastic contact piece 21 is the inner opposing contact surface 22, and as a result of the male connector terminal 30 being pressed against the inner opposing contact surface 22 by the elastic contact piece 21, the male connector terminal 30 is held pinched in the pinching portion 23.

The entire female connector terminal 20 is constituted by the metal material 1 including the surface layer 11 according to the above-described embodiment. Here, the face on which the surface layer 11 of the metal member 1 is formed faces the inner side of the pinching portion 23, and is disposed so as to constitute the surfaces of the elastic contact piece 21 and the inner opposing contact surface 22 that face each other. By disposing the surface layer 11 at these locations, when the male connector terminal 30 is inserted into and slid against the pinching portion 23 of the female connector terminal 20, low contact resistance can be achieved at the contact portion between the female connector terminal 20 and the male connector terminal 30. Also, even if the surface layer 11 is heated due to a current passing therethrough or use in a high-temperature environment, the state of low contact resistance is maintained.

Note that here, a form in which the entire female connector terminal 20 is constituted by the metal material 1 according to the above-described embodiment that includes the surface layer 11 (and the intermediate layer 10b) was described, but as long as the surface layer 11 (and the intermediate layer 10b) is formed at least on the surface of the contact portion that comes in contact with the partner conductive member, that is the surface of the embossed portion 21a of the elastic contact piece 21 and the inner opposing contact surface 22, the surface layer 11 may be formed over any range. A partner conductive member such as the male connector terminal 30 may be constituted by any material, but similarly to the female connector terminal 20, a form in which the conductive member is constituted by the metal material 1 according to the above-described embodiment including the surface layer 11 or a form in which the conductive member is constituted by a metal material in which an Au layer is formed on the outermost surface thereof can be given as favorable examples. Also, in addition to a fitting female connector terminal such as that described above or alternatively a male connector terminal, the connection terminal according to the embodiment of the present disclosure can take various forms such as a press-fit terminal that is press-fitted to and connected to a through hole formed in a printed board.

### Working Examples

Working examples are described below. Unless specifically mentioned below, manufacturing and evaluation of samples was undertaken in the atmosphere and at room temperature. Note that the present invention is not limited to the working examples.

[Test Method]

(Manufacturing of Samples)

Raw material layers having a predetermined thickness as shown in Table 1 were layered on the surface of a non-contaminated Cu substrate. Specifically, first, a Ni intermediate layer with a thickness of 1.0 μm was formed using an electroless plating method. Furthermore, an Au layer was formed on the surface of the intermediate layer using an electroless plating method. A hard plating liquid containing 0.2% of Co was used to form the Au layer. The thickness of the Au layer was 0.4 μm.

Then, an In layer was formed on the surface of the Au layer. At this time, the following three samples were manufactured according to the presence or absence of the In layer and the forming method.

Sample A1: An In layer with a thickness of 0.05 μm was formed using an electroless plating method.

Sample A2: An In layer with a thickness of 0.01 μm was formed using an immersion method.

Sample B1: A sample in which only the Au layer was formed without an In layer being provided.

(Evaluation of the State of Surface Layer)

A depth-analysis AES measurement using Ar⁺ sputtering was performed on each sample after having been heated for 120 hours in the atmosphere at 170° C., and the distribution of constituent elements of the surface layer in the depth direction was evaluated. The measurement was performed to a sputter depth of 40 nm.

Also, 2θx-ray diffraction (XRD) was performed on the sample A1 (before heating) and the state of the surface layer was checked. A Cu Kα beam was used as the beam source.

(Evaluation of Contact Resistance)

The contact resistance of each sample (before heating) was measured. At this time, an Au plated emboss in which R=1 mm was brought into contact with the surface of each plate-shaped sample, and the contact resistance was measured while subjecting each sample to a contact load of up to 40N. The measurements were performed using a four-terminal method. The open circuit voltage was 20 mV, and the flowing current was 10 mA.

Furthermore, each sample was heated at 170° C. for 120 hours in the atmosphere. The contact resistance was measured similarly as described above after the samples had cooled down to room temperature.

[Test Results)

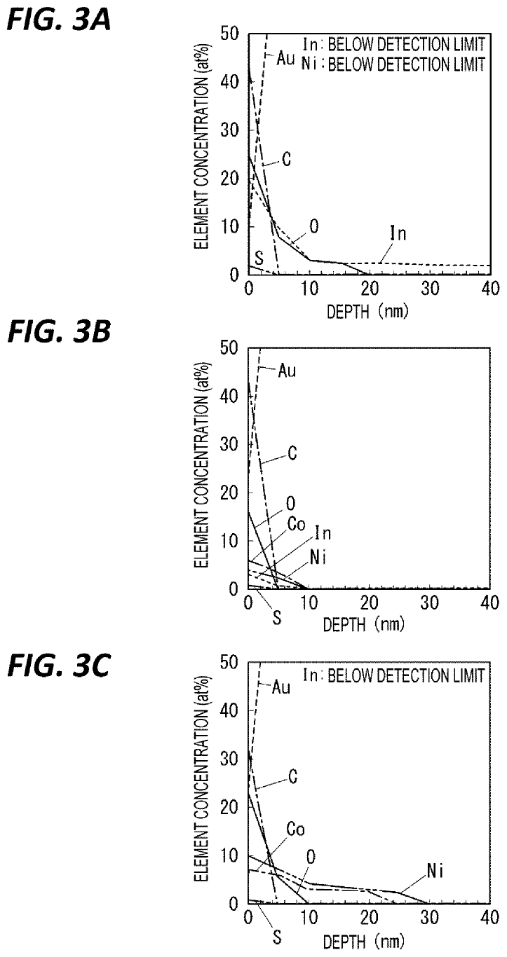

(State of Surface Layer) Table 1 shows, for each of the samples A1, A2, and B1, the thickness of each raw material layer and the concentration of metal elements in the outermost surfaces obtained through post-heating AES measurement. FIGS. 3A to 3C respectively show the concentration distribution of each element obtained from the samples A1, A2, and B1 through AES after heating. Here, the depth shown by the horizontal axis is an SiO₂ equivalent. The elements for which “below detection limit” is written were not detected at a concentration greater than or equal to the detection limit. While the concentration ratios of Au, In, Co, and Ni at the depth of 0 nm in FIGS. 3A to 3C express the total amount of these elements as 100 at %, the concentration ratios are the element concentration ratios shown in Table 1.

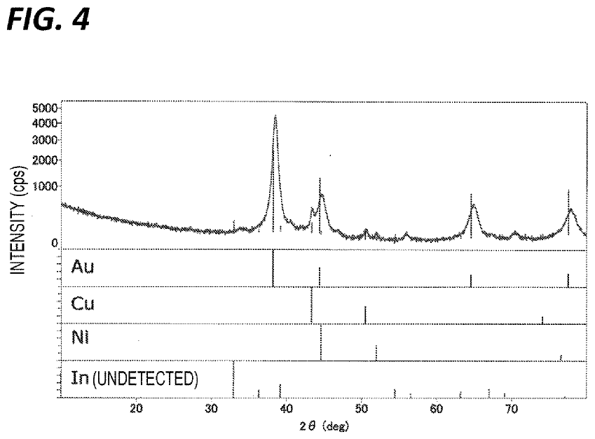

FIG. 4 shows the XRD measurement result of sample A1. In FIG. 4, in addition to the measurement data, the peak positions and intensities corresponding to individual Au, Cu, Ni, and In are shown as bars.

TABLE 1

| | Raw Material | | | | | | |
|---|---|---|---|---|---|---|---|
| | Layer (μm) | | | Element Concentration Ratio of | | | |
| | Au | In | Ni | Heated Outermost Surface (at %) | | | |
| | Layer | Layer | Layer | Au | In | Co | Ni |
| Sample A1 | 0.4 | 0.05 | 1.0 | 32 | 68 | 0 | 0 |
| Sample A2 | 0.4 | 0.01 | 1.0 | 65 | 9 | 17 | 9 |
| Sample B1 | 0.4 | — | 1.0 | 59 | 0 | 17 | 24 |

First, the distribution and state of In and Au in the surface layer was examined Looking at the element concentration distribution shown in FIGS. 3A and 3B and the element concentration ratios shown in Table 1 of samples A1 and A2, it was confirmed that in both samples, Au and In were present in the surface layer including the outermost surface. Accordingly, it is understood that an Au—In alloy was formed in the surface layer including the outermost surface in both samples A1 and A2.

In the results of sample A1 shown in FIG. 3A, the concentration of In is highest in the outermost surface and decreases toward the inner portion of the surface layer, but this decrease becomes more moderate at a depth of approximately 10 nm, and maintains a certain concentration even at a depth of 40 nm. In this way, In is distributed in not only the vicinity of the outermost surface but also in the inner portion region, and it can be said that, in at least the post-heating state, the surface layer takes on a single-layer structure such as that shown in FIG. 1B, and in that single-layer structure, an Au—In alloy is formed throughout a region up to at least a depth of 40 nm. When the distribution of In shown in FIG. 3A is extrapolated, it can be conceived that In is distributed to a depth of 0.05 μm, which corresponds to the thickness of the In layer used as the raw material layer.

On the other hand, in the results of sample A2 shown in FIG. 3B, the concentration of In is highest in the outermost surface and monotonically decreases toward the inner portion of the surface layer. The concentration of In is essentially zero at a depth of 10 nm, which corresponds to the thickness of the In layer used as the raw material layer. Accordingly, it can be conceived that an In layer is distributed from the outermost surface of the surface layer to a depth of 0.01 μm, and the surface layer has a multi-layer structure such as that shown in FIG. 1A that includes a lower layer formed of an Au portion and an upper layer formed of a high-concentration In portion with a thickness of approximately 10 nm.

Looking at the XRD results of the sample A1 shown in FIG. 4, four refraction peaks can be observed at a position near the peaks of Au alone shown as bars. However, when the position of each peak is carefully observed, each peak is shifted to the high-angle side relative to the peaks of Au alone. This can be interpreted as In having been solidified in Au, and the lattice constant of Au having changed to that of Au alone. That is, it can be conceived that an Au—In solid solution has formed in the surface layer. According to a detailed analysis, the lattice constant of Au has changed from 4.079×10⁻¹ nm to 4.064×10⁻¹ nm.

Also, in the XRD results, no peaks corresponding to In or an Au—In intermetallic compound were detected. Based on these results, it can be appreciated that almost the entire amount of In is in a state of being solidified to Au and is present in the surface layer.

Next, the distribution Co and Ni in the surface layer after heating was examined Co was contained in the In layer and the Au layer layered on each other as raw material layers, and Ni formed the intermediate layer. Note that, in all of samples A1, A2, and B1, it was confirmed that neither Co or Ni were present at a concentration greater than or equal to the detection limit in the outermost surface of the surface layer before heating.

First, looking at the results of sample B1 shown in FIG. 3C, both Co and Ni were detected in the surface layer. Furthermore, the concentrations of these elements were highest in the outermost surface. Accordingly, in the case where an Au layer without In was formed on the surface of the metal material, it is understood that Co and Ni diffused in the surface layer due to heating and concentrated in the outermost surface.

On the other hand, in sample A2 shown in FIG. 3B, while both Co and Ni were detected in the surface layer, the concentrations thereof were lower than those in the case of sample B1. The concentration of Ni in particular was largely reduced. The reduction in the concentrations of both Co and Ni sharply decreased from the outermost surface toward the inner portion, and were almost undetectable at a depth of approximately 10 nm. Accordingly, it can be understood that, as a result of containing In in addition to Au in the surface layer, the diffusion of Co and Ni to the outermost surface can be suppressed.

Furthermore, neither Co or Ni were detected in sample A1 shown in FIG. 3A. That is, the diffusion of Co and Ni to the outermost surface did not occur to a concentration greater than or equal to the AES detection limit. Accordingly, it can be understood that, by increasing the content of In in the surface layer, the diffusion of Co and Ni can be suppressed to a higher degree.

(Contact Resistance of Surface Layer)

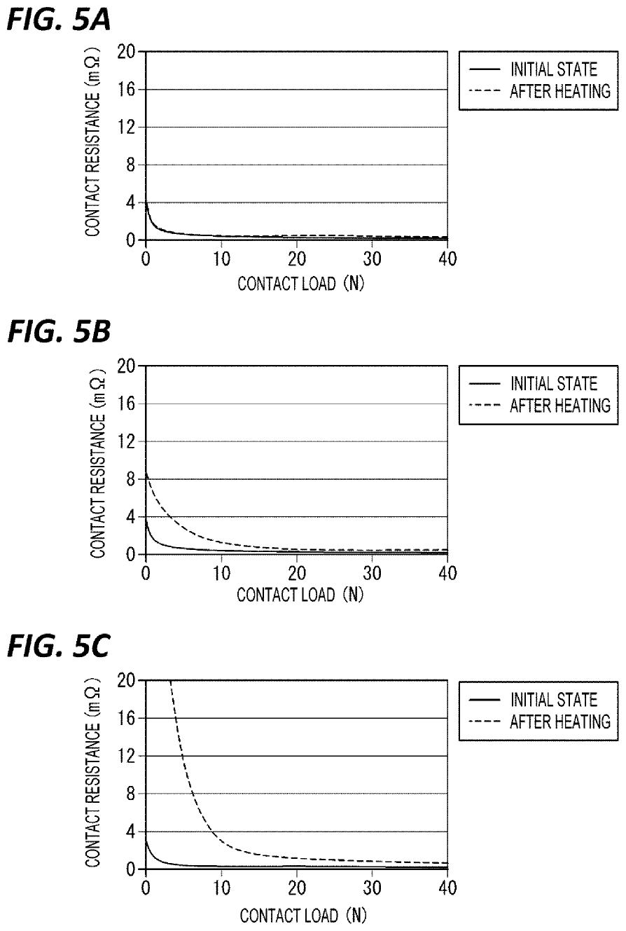

FIGS. 5A to 5C respectively show contact resistance measurement results of the samples A1, A2, and B1, obtained before and after heating. In comparing the measurement results, initial state values of each sample were approximately identical, and low contact resistances were obtained for each sample. While Au has extremely high electrical conductivity, it can be said that, due to the oxide film of In being easy to break, there was almost no increase in contact resistance resulting from In being contained in the surface layer of the samples A1 and A2 in which In is present in the outermost surface, when compared with sample B1 that does not include In.

Next, when the contact resistances after heating were compared, the results largely varied according to the sample. Specifically, in sample B1 shown in FIG. 5C, the contact resistance was largely increased due to heating. This result, as seen in the element concentration distribution in FIG. 3C, can be interpreted as being a result of Co and Ni diffused in the surface layer oxidizing in the outermost surface and increasing the contact resistance.

On the other hand, while the results of sample A2 shown in FIG. 5B in which In was contained in the surface layer indicate an increase in contact resistance after heating, the amount of the increase was far more suppressed than that of the sample B1. This result, as seen in the element concentration distribution in FIG. 3B, can be associated with a reduction, caused by adding In, in the concentration of Co and Ni diffusing in the surface layer when heated. That is, as a result of the amount of Co and Ni diffusing in the surface layer, an increase in contact resistance caused by oxidization of these elements can be kept small

Regarding the results of sample A1 shown in FIG. 5A in which the content of In was increased, an increase in contact resistance caused by heating was further suppressed, and there was little change from the value of the contact resistance measured in the initial state before heating. This result can be associated with the fact that Co and Ni were not detected in the AES measurement shown in FIG. 3A. That is, as a result of these elements that increase contact resistance through oxidization not diffusing in the surface layer, there was almost no increase in contact resistance accompanying heating.

Although the embodiments of the present disclosure have been described in detail above, the present invention is not to be limited to the foregoing embodiments, and various modifications are possible without departing from the gist of the present invention. The present application claims the benefit of priority based on Japanese Patent Application No. 2019-007135 applied for on Jan. 18, 2019.

### LIST OF REFERENCE NUMERALS

1 Metal material
10 Base material
10a Substrate
10b Intermediate layer
11 Surface layer
11a Au portion
11b High-concentration In portion
20 Female connector terminal
21 Elastic contact piece
21a Embossed portion
22 Inner opposing contact surface
23 Pinching portion
30 Male connector terminal

1. A metal material comprising:
a base material; and
a surface layer formed on the base material,
wherein the surface layer contains Au and In, and at least In is present at an outermost surface.

2. The metal material according to claim 1,
wherein at least one of the surface layer and the base material contains an easily oxidizable metal, other than In, that is more susceptible to oxidization than Au, and
when the metal material is heated to 170° C., an increase in the concentration of the easily oxidizable metal in the outermost surface is below a detection limit in Auger electron spectroscopy.

3. The metal material according to claim 1,
wherein at least a portion of In in the surface layer forms an Au—In alloy.

4. The metal material according to claim 3,
wherein at least a portion of the Au—In alloy is a solid solution in which In is solidified in Au.

5. The metal material according to claim 1,
wherein both Au and In are present in the outermost surface of the surface layer.

6. The metal material according to claim 1,
wherein the surface layer includes an Au portion of which the main component is Au, and a high-concentration In portion containing a higher concentration of In than the Au portion.

7. The metal material according to claim 6,
wherein the high-concentration In is formed on a surface of the Au portion and is exposed at the outermost surface.

8. The metal material according to claim 1,
wherein an entirety of the surface layer has a single-layer structure constituted by a single layer including an Au—In alloy.

9. The metal material according to claim 1,
wherein In is distributed in a region spanning from the outermost surface to at least a depth of 0.01 μm.

10. The metal material according to claim 1,
wherein In is distributed in a region spanning from the outermost surface to at least a depth of 0.05 μm.

11. The metal material according to claim 1,
wherein the base material has an intermediate layer formed on a substrate, and
the intermediate layer includes at least one of Ni, Cr, Mn, Fe, Co, and Cu.

12. The metal material according to claim 1,
wherein the surface layer contains Co.

13. The metal material according to claim 1,
wherein the content of an additional element other than Au and In in the surface layer is 5% or less.

14. The metal material according to claim 1,
wherein the In content of the surface layer overall is 10% or more in terms of atomic ratio relative to Au.

15. The metal material according to claim 1,
wherein the content of In, in terms of the number of atoms, in the surface layer overall is smaller than that of Au.

16. The metal material according to claim 1,
wherein the thickness of the surface layer is 0.1 μm or more.

17. A connection terminal constituted by the metal material according to claim 1,
wherein the surface layer is formed on a surface of the base material at least at a contact portion that comes into electrical contact with a partner conductive member.
